(19) United States
(12) Patent Application Publication
(10) Pub. No.: US 2013/0207749 A1
(43) Pub. Date: Aug. 15, 2013

(54) DIGITAL ATTENUATOR WITH REDUCED PHASE DIFFERENCE

(71) Applicant: ELECTRONICS AND TELECOMMUNICATIONS RESEARCH INSTITUTE, (US)

(72) Inventors: Dong Hwan SHIN, Daejeon (KR); Seong Mo MOON, Daejeon (KR); In Bok YOM, Daejeon (KR)

(73) Assignee: ELECTRONICS AND TELECOMMUNICATION RESEARCH INSTITUTE, Daejeon (KR)

(21) Appl. No.: 13/760,834

(22) Filed: Feb. 6, 2013

(30) Foreign Application Priority Data
Feb. 13, 2012 (KR) 10-2012-0014312

(51) Int. Cl. H01P 1/22

(52) U.S. Cl. CPC H01P 1/22
USPC 333/81 R

(57) ABSTRACT

Disclosed is a digital attenuator, and more particularly, a digital attenuator for improving a performance in various respects, and also provided is a structure for reducing a phase difference of the digital attenuator by equipping an inductor as a phase retardation element.

### CROSS-REFERENCE TO RELATED APPLICATION

This application claims the priority benefit of Korean Patent Application No. 10-2012-0014312, filed on Feb. 13, 2012, in the Korean Intellectual Property Office, the disclosure of which is incorporated herein by reference.

### BACKGROUND

1. Field of the Invention

The present invention relates to a digital attenuator, and more particularly, to a digital attenuator for enhancing a performance in various respects.

2. Description of the Related Art

In general, a digital attenuator is used to generate change in a signal magnitude in a microwave band. More particularly, the digital attenuator may have a specific attenuation value based on an operation state of a switching element used in a circuit configuration. A Monolithic Microwave Integrated Circuit (MMIC) attenuator may obtain an attenuation value of greater than 8 decibels (dB) in an S-band that is in a range of 2 to 4 gigahertz (GHz), without a phase difference based on a state transition.

In general, achieving an attenuation quantity corresponding to a standard may be necessary for the digital attenuator, without a difference. More particularly, the digital attenuator may be utilized for adjusting a relative magnitude of input/output signals of an array element of an antenna in a system requiring a control of an antenna beam direction such as a phase array antenna system or a radar system. A high accuracy in the attenuating quantity of the digital attenuator being present, and an absence of an occurrence of a phase difference during attenuating operation may also be important since the digital attenuator controls the signal magnitude and a phase simultaneously. With current developments of minimizing the phase array antenna system or the radar system, use of an MMIC attenuator that is easy to control and relatively accurate in attenuating is widespread.

Conventionally, a digital MMIC attenuator may be embodied in a structure using a switching element, a Pi-type attenuator circuit, or a T-type attenuator circuit. The digital MMIC attenuator may have a switched path structure for achieving a desired attenuation value by changing a signal path.

FIGS. 1 and 2 are diagrams illustrating a conventional digital attenuator.

Referring to FIG. 1, the conventional digital attenuator, that is, a switched T-type attenuator may include a plurality of field effect transistor (FET) switching elements 103 and 104 and a plurality of resistance elements 105 to 107 of a T-type attenuator. The plurality of the resistance elements 105 to 107 may be resistance elements that configure the T-type attenuator. The plurality of FET switching elements 103 and 104 may perform complementary operation of ON/OFF states.

In the conventional digital attenuator of FIG. 1, when a first FET switching element 103 is switched ON, and a second FET switching element 104 is switched OFF, a signal path may be in an arrangement of an input 101, the first switching element 103, and an output 102. Such a state may be referred to as a reference state. When the first FET switching element 103 is switched OFF, and the second FET switching element is switched ON, the signal path may be in an arrangement of the input 101, the resistance elements 105 to 107 of the T-type attenuator, and the output 102. Such a state may be referred to as an attenuation state.

In such a conventional digital attenuator, a phase difference between the reference state and the attenuation state may occur, and the phase difference may increase in proportion to an attenuation value of the T-type attenuator.

Referring to FIG. 2, a conventional digital attenuator, that is, a low phase variation switched T-type attenuator, to which a low phase variation is applied, is provided. The conventional digital attenuator of FIG. 2 may decrease a phase difference by inserting a different length of transmission lines 211 to 213 in order to remove the phase difference of the conventional digital attenuator of FIG. 1. However, in a case of an attenuator that operates in a relatively low frequency band in a range of 2 to 4 GHz, such as in an S-band, a considerably long transmission line may be required for reducing the phase difference. Accordingly, problems may arise in embodying such an attenuator, and a performance of the attenuator may be degraded, for example, an insertion loss.

### SUMMARY

An aspect of the present invention provides a structure for reducing a phase difference of a digital attenuator by equipping an inductor as a phase retardation element.

Another aspect of the present invention also provides a digital attenuator that is able to attenuate in a relatively low frequency band such as in an S-band, and has a small phase difference.

According to an aspect of the present invention, there is provided an attenuator, including a switching element connected in parallel between a signal input end and a signal output end, at least one resistance element connected via a different path between the signal input end and the signal output end, and an inductor connected in series between at least one of the signal input end and the signal output end and the at least one resistance element.

The inductor may include a first inductor connected in series between the signal input end and the at least one resistance element, and a second inductor connected in series between the at least one resistance element and the signal output end.

Each of the at least one resistance element is a resistance element of a T-type attenuator, and the inductor is connected to each of both ends of the T-type attenuator.

According to another aspect of the present invention, there is provided a Monolithic Microwave Integrated Circuit (MMIC) attenuating apparatus for processing an S-band signal, the attenuating apparatus including a switching element connected in parallel between a signal input end and a signal output end with respect to the S-band signal, at least one resistance element connected via a different path between the signal input end and the signal output end, and an inductor connected in series between at least one of the signal input end and the signal output end and the at least one resistance element.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIGS. 1 and 2 are diagrams illustrating a conventional digital attenuator;

FIG. 3 is a diagram illustrating a configuration of a digital attenuator according to an embodiment of the present invention;

FIG. 4 is a diagram illustrating another digital attenuator to describe a performance of the digital attenuator of FIG. 3; and

FIG. 5 is a diagram illustrating an example of a result of simulating the digital attenuators of FIGS. 3 and 4.

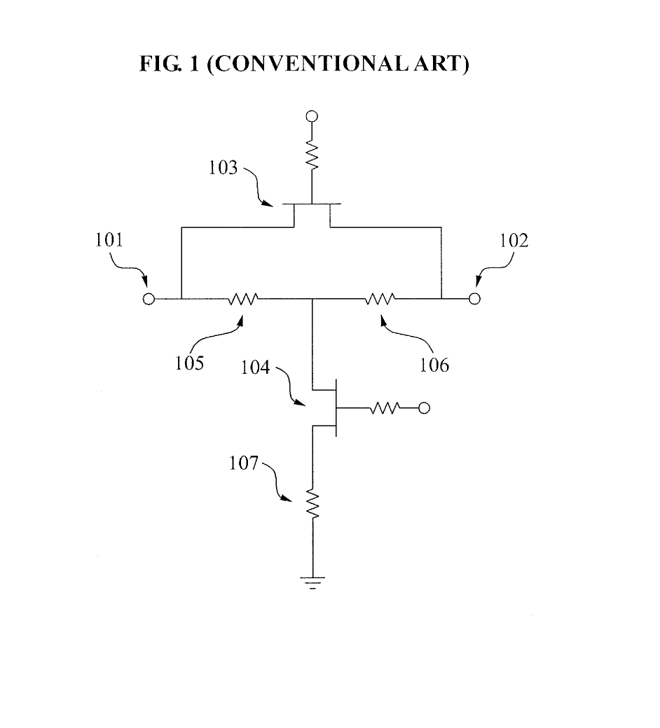

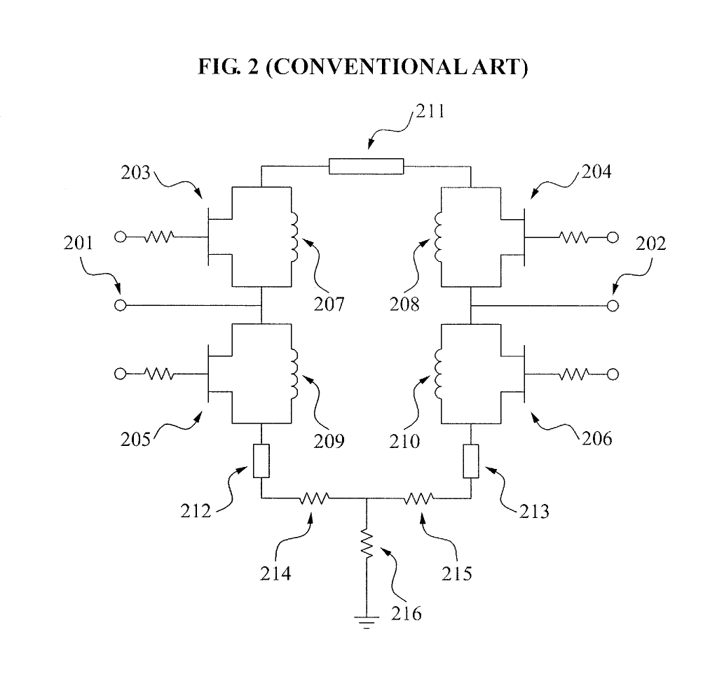

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

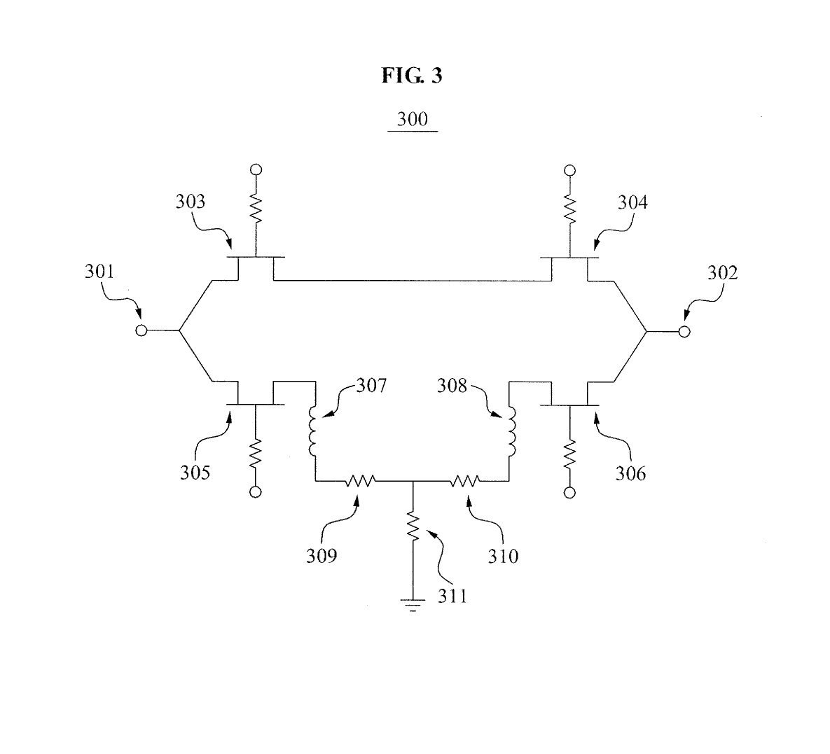

FIG. 3 is a diagram illustrating a configuration of a digital attenuator according to an embodiment of the present invention.

Referring to FIG. 3, as a first embodiment, the digital attenuator 300 may include at least four of field effect transistor (FET) switching elements 303 to 306, a plurality of resistance elements 309 to 311 configuring a T-type attenuator, and a plurality of inductors 307 and 308. Here, the plurality of inductors 307 and 308 may be inserted to correct a difference of a reference state path and a difference of an attenuation state path.

Here, when a first FET switching element 303 and a second FET switching element 304 are switched ON, and a third FET switching element 305 and a fourth FET switching element 306 are switched OFF, a signal path may be in a sequence of an input 301, the first FET switching element 303, the second FET switching element 304, and an output 302. Such a state may be referred to as a reference state. Also, when the first FET switching element 303 and the second FET switching element 304 are switched OFF, and the third FET switching element 305 and the fourth FET switching element 306 are switched on, the signal path may be in a sequence of the input 301, the third FET switching element 305, a first inductor 307, the plurality of resistance elements 309 to 311 configuring the T-type attenuator, a second inductor 308, the fourth FET switching element 306, and the output 302. Such an instance may be referred to as an attenuation state.

That is, the digital attenuator 300 may reduce a phase difference of a signal that is output in the attenuation state, by disposing at least one inductor in the attenuation state path.

That is, the digital attenuator 300 may include at least one switching element connected in parallel between a signal input end and a signal output end, at least one resistance element connected via a different path between the signal input end and the signal output end, and an inductor connected in series between at least one of the signal input end and the signal output end and the at least one resistance element.

More particularly, the inductor may include a first inductor connected in series between the signal input end and the at least one resistance element, and a second inductor connected in series between the at least one resistance element and the signal output end.

Also, each of the at least one resistance element may be a resistance element of the T-type attenuator, and the inductor may be connected to each of both ends of the T-type attenuator.

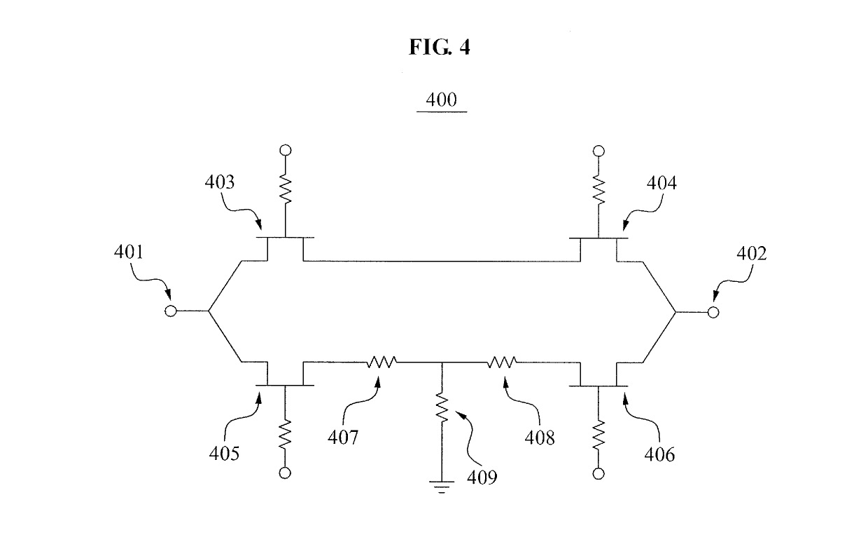

For example, when the inductors 307 and 308 are not disposed in the digital attenuator 300, the digital attenuator 300 may be embodied as shown in FIG. 4. That is, FIG. 4 is a diagram illustrating another digital attenuator to describe a performance of the digital attenuator 300 of FIG. 3.

Referring to FIG. 4, the digital attenuator 400 is not equipped with an inductor unlike the digital attenuator 300 of FIG. 3. That is, the digital attenuator 400 may include at least four of FET switching elements 403 to 406, and a plurality of resistance elements 407 to 409 configuring a T-type attenuator.

In a case of a reference state, a signal of the digital attenuator 400 may be transmitted as in a case of a signal of the digital attenuator 300. However, in a case of an attenuation state, the signal of the digital attenuator 400 may be transmitted in a sequence of an input 401, a third FET switching element 405, the plurality of resistance elements 407 to 409 configuring the T-type attenuator, a fourth FET switching element 406, and an output 402, without passing through the inductor.

Accordingly, in the digital attenuator 400, a signal may be attenuated in the attenuation state, however, a phase of a signal passing through an attenuation state path may precede a phase of a signal passing through a reference state path.

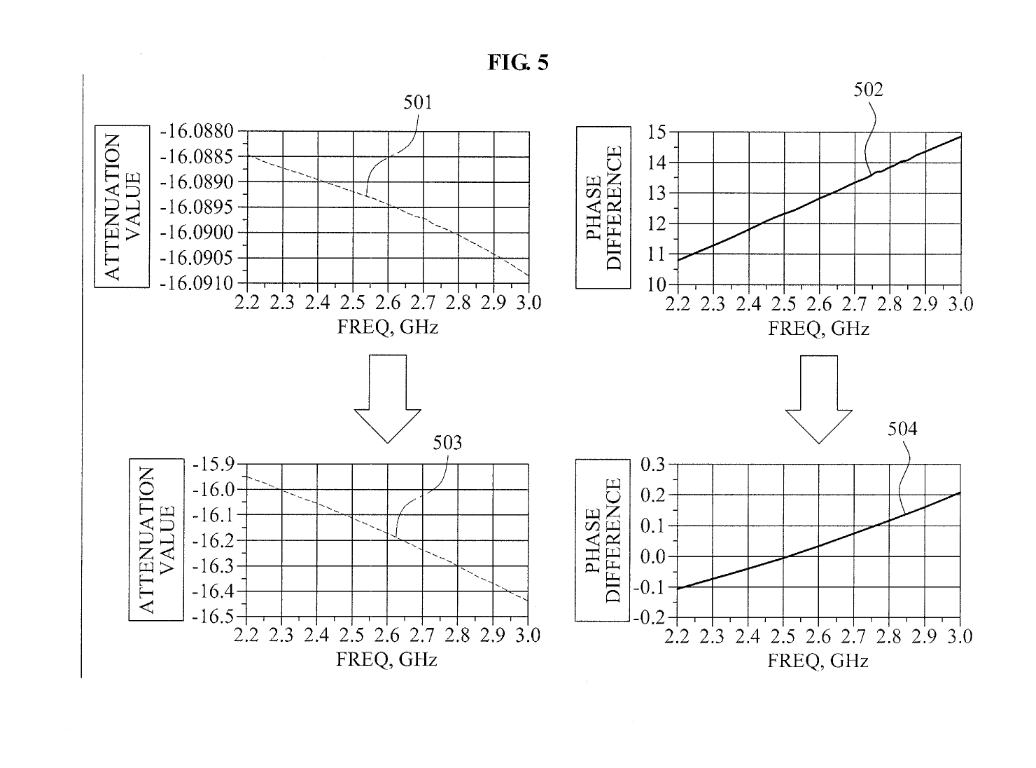

FIG. 5 is a diagram illustrating an example of a result of simulating the digital attenuators of FIGS. 3 and 4. According to an embodiment, the simulation of the digital attenuators is performed at an attenuation value of 16 dB. In graphs 501 to 503, a result of the simulation may illustrate a difference of an attenuation value of a signal passing through a reference state path and an attenuation value of a signal passing through an attenuation state path. In graphs 502 to 504, a phase difference of the signal passing through the reference state path and the signal passing through the attenuation state path is illustrated.

Referring to the graph 501 of FIG. 5, the digital attenuator 400 of FIG. 4 illustrates that an attenuation is performed accurately in an S-band frequency. However, referring to 502, in the digital attenuator 400, a phase difference of a signal passing through a reference state path and a signal passing through an attenuation state path is approximately 13 degrees in 2.6 GHz, that is, a center frequency.

In the digital attenuator 400, the transmission line of approximately 1500 micrometers (μm) may need to be inserted in order to reduce the difference phase, by using a method of a conventional digital attenuator in which a transmission line is inserted. However, such a structure may be difficult to embody in a minimized MMIC, and although embodied, an issue such as an insertion loss, a decreased bandwidth for use, and the like may arise.

The digital attenuator 300 of FIG. 3 according to embodiments of the present invention may equip at least one inductor to reduce a phase difference of a signal passing through an attenuation state path. More particularly, the digital attenuator 300 may insert an inductor for a phase retardation between a resistance element of a T-type attenuator and an FET switching element. That is, the inductor may reduce the phase difference between the signal passing through the attenuation state path and a signal passing through a reference state path at both ends of the T-type attenuator.

Referring to a graph 503 of FIG. 5, the digital attenuator 300 illustrates an accurately performed attenuation in which approximately 16 dB of an attenuation value in an S-band frequency is obtained as shown in the graph 501.

However, referring to a graph 504, the digital attenuator 300 may have the phase difference of ±0.15 degrees in a band in a range of 2.2 to 3.0 GHz. Accordingly, the digital attenuator 300 may have a small phase difference, when compared to the graph 503.

Such a digital attenuator may be provided in a relatively small size of 600 μm×400 μm as an embodiment.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An attenuator, comprising:
a switching element connected in parallel between a signal input end and a signal output end;
at least one resistance element connected via a different path between the signal input end and the signal output end; and
an inductor connected in series between at least one of the signal input end and the signal output end and the at least one resistance element.

2. The attenuator of claim 1, wherein the inductor comprises:
a first inductor connected in series between the signal input end and the at least one resistance element; and
a second inductor connected in series between the at least one resistance element and the signal output end.

3. The attenuator of claim 1, wherein each of the at least one resistance element is a resistance element of a T-type attenuator, and
the inductor is connected to each of both ends of the T-type attenuator.

4. A Monolithic Microwave Integrated Circuit (MMIC) attenuating apparatus for processing an S-band signal, the attenuating apparatus comprising:
a switching element connected in parallel between a signal input end and a signal output end with respect to the S-band signal;
at least one resistance element connected via a different path between the signal input end and the signal output end; and
an inductor connected in series between at least one of the signal input end and the signal output end and the at least one resistance element.
